(19) United States
(12) Patent Application Publication
(10) Pub. No.: US 2018/0062944 A1
(43) Pub. Date: Mar. 1, 2018

(54) API RATE LIMITING FOR CLOUD NATIVE APPLICATION

(71) Applicant: CISCO TECHNOLOGY, INC., San Jose, CA (US)

(72) Inventors: Alexander B. Altman, Chapel Hill, NC (US); Sunil Cherukuri, Cary, NC (US); Xiao Hu Gao, Chapel Hill, NC (US)

(73) Assignee: CISCO TECHNOLOGY, INC., San Jose, CA (US)

(21) Appl. No.: 15/254,764

(22) Filed: Sep. 1, 2016

(51) Int. Cl. H04L 12/24; H04L 12/26

(52) U.S. Cl. CPC H04L 41/5019; H04L 67/10; H04L 43/0876

(57) ABSTRACT

A method is described and in one embodiment includes intercepting an API call destined for an application executing on a host server; accessing a Service Level Agreement (“SLA”) profile for the application, wherein the SLA indicates performance guarantees for the application; determining resource utilization for the host server and resource utilization for the current application and other applications running on that server; comparing the performance guarantees with the host server and application resource utilization to determine whether performance guarantees can be met if the API call is forwarded to the application based on the host server resource utilization; and, if it determined that the performance guarantees cannot be met if the API call is forwarded to the application, refraining from forwarding the API call to the application.

### TECHNICAL FIELD

This disclosure relates in general to the field of communications networks and, more particularly, to techniques for Application Programming Interface (“API”) rate limiting for cloud native applications based on host hardware regulations and application SLA guarantees in such communications networks.

### BACKGROUND

Cloud platforms provide deployment flexibility and elasticity required by modern applications; however, with that flexibility comes a variety of challenges. Many of the services deployed within the cloud platform are deployed as micro-services, each with their own APIs, and resources. Those resources that get consumed via external API calls may become swamped in a very similar manner as a traffic on a highway in that everything (either for a single application's path to return to the caller or many applications) gets delayed at a few bottlenecks. A key method for maintaining fluid interaction between services and the continued access to resources across the cloud is API rate limiting.

Rate limiting in general may be problematic for a variety of reasons. Often, rate limiting is extremely simple or naive. Current API rate limiting mechanisms may be essentially static (X calls per Y time units). Such rate limiting mechanisms may be unaware of current API usage patterns, burst cycles/patterns, resource utilization and state of the host(s) on which the service is deployed, and availability of the service itself. Existing rate limiting procedures do not possess the necessary context to make good Service Level Agreement (“SLA”)-based decisions.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a cloud service model stack in accordance with features of the present disclosure;

FIG. 2 is a simplified block diagram illustrating concepts of private, public, and hybrid clouds in accordance with features of the present disclosure;

FIG. 3 is a simplified block diagram of cloud-based deployment illustrating a first example scenario in which techniques for API rate limiting for cloud native applications based on host hardware regulations and application SLA guarantees may be implemented in accordance with embodiments described herein;

FIG. 4 is a simplified block diagram of cloud network illustrating another example scenario in which techniques for API rate limiting for cloud native applications based on host hardware regulations and application SLA guarantees may be implemented in accordance with embodiments described herein;

FIG. 5 is a simplified block diagram of cloud network illustrating yet another example scenario in which techniques for API rate limiting for cloud native applications based on host hardware regulations and application SLA guarantees may be implemented in accordance with embodiments described herein;

FIG. 6 is a simplified block diagram of cloud network 100 generally representative of the example scenarios illustrated in FIGS. 3-5 in which techniques for API rate limiting for cloud native applications based on host hardware regulations and application SLA guarantees may be implemented in accordance with embodiments described herein;

FIG. 7 is a flow diagram of steps that may be executed in connection with a technique for API rate limiting for cloud native applications based on host hardware regulations and application SLA guarantees in accordance with embodiments described herein;

FIG. 8 illustrates a simplified block diagram of an API rate limiter for implementing techniques for API rate limiting for cloud native applications based on host hardware regulations and application SLA guarantees in accordance with embodiments described herein; and

FIG. 9 is a simplified block diagram of a machine comprising an element of a conferencing platform in which techniques for API rate limiting for cloud native applications based on host hardware regulations and application SLA guarantees may be implemented in accordance with embodiments described herein.

### DESCRIPTION OF EXAMPLE EMBODIMENTS

### Overview

A method is described and in one embodiment includes intercepting an API call destined for an application executing on a host server; accessing a Service Level Agreement (“SLA”) profile for the application, wherein the SLA indicates performance guarantees for the application; determining resource utilization for the host server and resource utilization for the current application and all other applications running on that server; comparing the performance guarantees with the host server and application resource utilization to determine whether performance guarantees can be met if the API call is forwarded to the application based on the host server resource utilization; and, if it determined that the performance guarantees cannot be met if the API call is forwarded to the application, refraining from forwarding the API call to the application.

### Example Embodiments

As used herein, the term “cloud service provider” (or simply “cloud provider”) refers to an enterprise or individual that provides some component of cloud computing, such as Infrastructure as a Service (“IaaS”), Software as a Service (“SaaS”), Platform as a Service (“PaaS”), for example, to other enterprises or individuals (“cloud users”) in accordance with a Service Level Agreement (“SLA”). For example, a typical cloud storage SLA may specify levels of service, as well as the recourse or compensation to which the cloud user is entitled should the cloud service provider fail to provide the service as described in the SLA. Examples of cloud service providers include, but are not limited to, Amazon®, Google®, Citrix®, IBM®, Rackspace®, and Salesforce.com®.

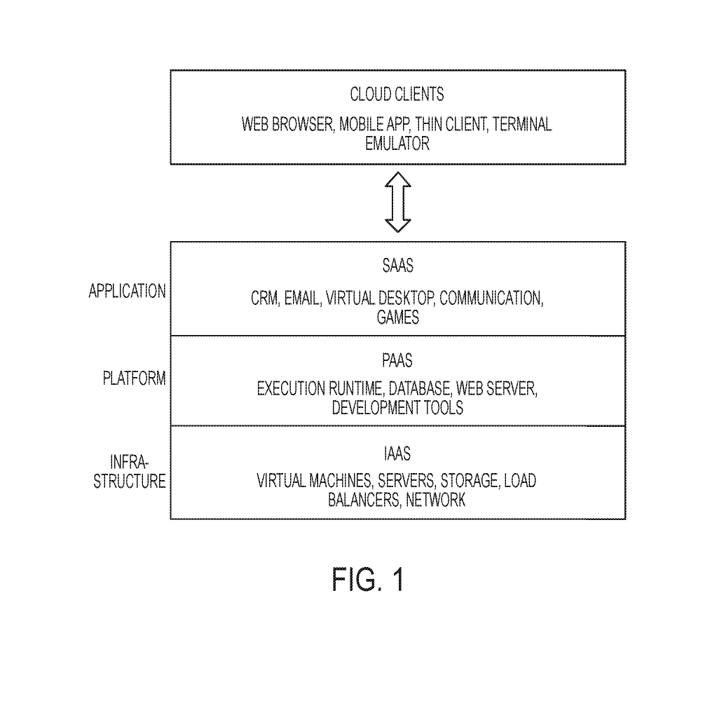

Cloud computing enables on-demand network access to a shared pool of configurable computing resources in a scalable, flexible, and resilient manner. Cloud service providers offer services according to different models, including IaaS, PaaS, and SaaS. These models offer increasing levels of abstraction and as such are often represented as layers in a stack, as illustrated in FIG. 1; however, the models need not be related. For example, a program may be run on and accessed directly from IaaS without it being wrapped as SaaS. Similarly, a cloud provider may provide SaaS implemented on physical machines without utilizing the “underlying” PaaS or IaaS layers.

One commonly used method for accessing and managing cloud resources is through interface referred to as cloud Application Programming Interfaces (“APIs”), which are offered by the cloud provider. Cloud APIs are APIs used to build and interact with applications in a cloud computing environment. Cloud APIs allow software to request data and computations from one or more services through a direct or indirect interface. Cloud APIs may expose their features via Simple Object Access Protocol (“SOAP”), Representational State Transfer (“REST”), Remoted Procedure Call (“RPC”), programming APIS, and others, for example. Vendor specific and cross-platform interfaces may be available for specific functions. Cross-platform interfaces enable applications to access services from multiple providers without having to be rewritten, but typically have less functionality than vendor-specific interfaces. IaaS APIs enable modification of resources available to operate an application. Functions of IaaS APIs (or “infrastructure APIs”) include provisioning and creation of components, such as virtual machines. APIs for implementing SaaS (or “service APIs”) provide an interface into a specific capability provided by a service explicitly created to enable that capability. Database, messaging, web portals, mapping, e-commerce and storage are all examples of service APIs. APIs for implementing SaaS (or “application APIs”) provide mechanisms for interfacing with and extending cloud-based applications, such as Customer Relationship Management (“CRM”), Enterprise Resource Planning (“ERP”), social media, and help desk applications.

A private cloud is a cloud operated for the sole use of a single organization or enterprise. Private clouds may be managed internally or by a third party and hosted internally or externally. A public cloud is a cloud in which services are provided over a network that is open to the public. Technically, there may be little or no difference architecturally between a public and a private cloud; however, security considerations are substantially different for services that are made available by a public cloud service provider over a non-trusted network. Public cloud services providers, such as Amazon Web Services (“AWS”), Microsoft, and Google, own and operate the infrastructure at their data center and access is typically via the Internet or via a direct connect service offered by the cloud service provider.

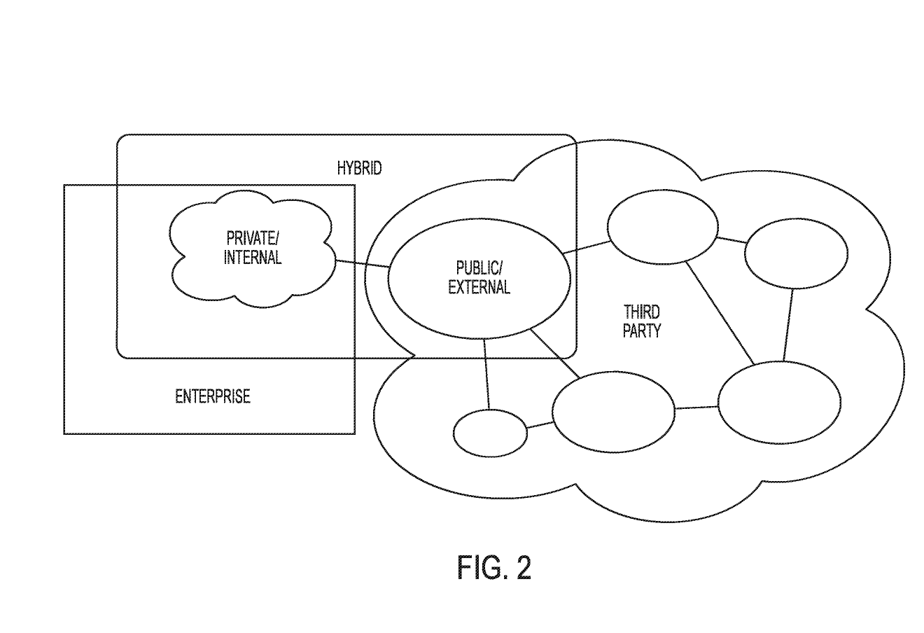

A hybrid cloud is a combination of two or more clouds that each remain distinct entities but are bound together, thereby offering the benefits of multiple deployment models. A hybrid cloud service crosses isolation and provider boundaries so that it cannot be simply categorized as public or private and enables extension of the capacity and/or the capability of a cloud service by aggregation, integration, and/or customization with another cloud service. In one example hybrid cloud use case, an organization stores sensitive client data on a private cloud application that is interconnected to a business intelligence application provided on a public cloud as a software service. In another example hybrid cloud use case, an IT organization may utilize public cloud resources to meet temporary capacity needs that cannot be met by a private cloud of the organization. This capacity enables hybrid clouds to employ “cloud bursting,” in which in which an application runs in a private cloud or data center and “bursts” to a public cloud when the demand for computing capacity increases, for scaling across clouds such that an organization only pays for extra compute resources as and when they are needed. FIG. 2 illustrates the concepts of private, public, and hybrid clouds.

A homogenous cloud is one in which the entire software stack, from the hypervisor through the various intermediate management layers to the end-user portal is provided by a single vendor. In contrast, a heterogeneous cloud integrates components from two or more vendors at the same and/or different levels.

In accordance with features of embodiments described herein, a mechanism is provided for implementing an intelligent cloud application and host resource aware rate limiting function across a heterogeneous cloud infrastructure. In certain embodiments, the SLA policy of an application, which may be a cloud native application, may be set against the cloud provider's SLA offerings. For instance, an ERP application may be set to the lowest of SLA guarantees (e.g., Tier III) and a web store application may be set to the highest of SLA guarantees (e.g., Tier I). In order to implement the embodiments described herein, the potential usage and usage patterns in which certain applications consume host resources must be understood. In particular, it is necessary to consider the host's current hardware usage (e.g., CPU, memory, disk consumption) in view of the SLA guarantees of the various applications executing on the host. For example, if the host's disk resource is being consumed at 99% and an application with a Tier I SLA guarantee is not yet using the disk, then it is advisable to rate limit the API calls by Tier III applications on that host to open up the necessary slack for the Tier I application. In particular, embodiments described herein provide mechanisms for ensuring that cloud users are getting the services they pay for in the form of SLA guarantees for their applications. These mechanisms buy time until the server cluster can relocate applications, or services, with lower tier SLA guarantees, isolate applications, or services, with higher tier SLA guarantees, or boot up more of applications, or services, with higher tier SLA guarantees elsewhere, all of which typically take longer to accomplish.

It will be recognized that SLA guarantees are specified in SLA profiles associated with applications as metadata and include values that identify various guarantees and/or constraints for different resource types and/or association with different application tiers. In some embodiments, SLA profiles may be associated with a host server and one or more applications hosted on the server ca eh server can inherit the SLA values defined in one of the profiles associated with the host server. In certain embodiments, an application can have different SLA profiles (and hence different values for SLA guarantees), depending on whether the application is instantiated on a bare-metal server, on a virtual machine, as a container or as an uni-kernel.

Embodiments described herein provide the ability to drop or queue traffic in order to restrict applications' API consumption based on known SLAs for a given service, making for a much more resilient infrastructure. For instance, when a host's disk is 99% utilized, lower tiered services may be rate limited until the disk consumption slacks to a certain level (e.g., 80%). At this point, if a local Tier I service spikes or begins consuming resources, those resources will be available to meet the SLA that is guaranteed and being paid for in connection with the service.

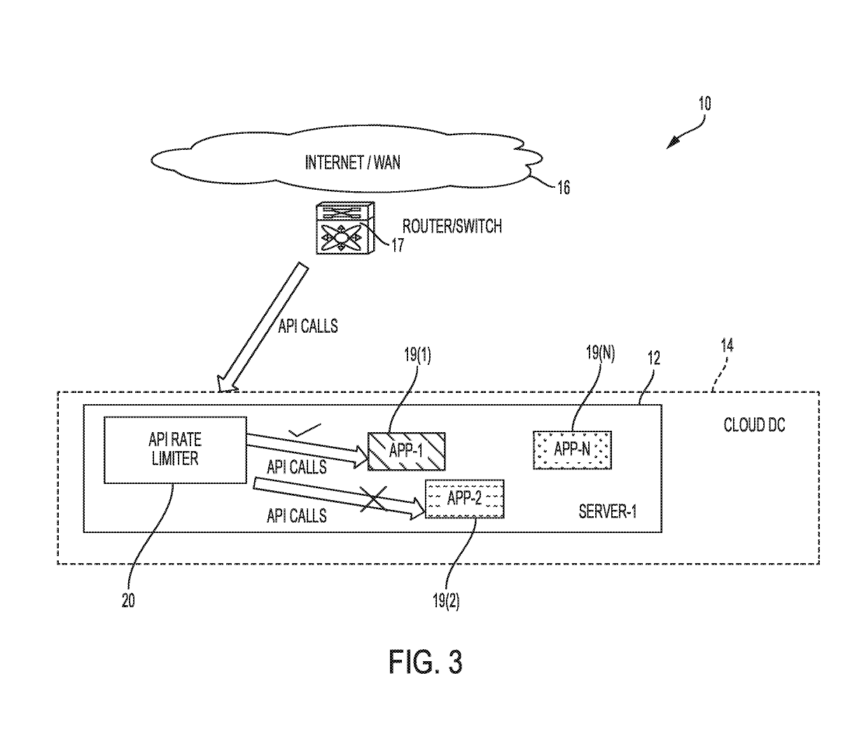

FIG. 3 is a simplified block diagram of cloud deployment 10 illustrating a first example scenario in which techniques for API rate limiting for cloud native applications based on host hardware regulations and application SLA guarantees may be implemented in accordance with embodiments described herein. As shown in FIG. 3, the deployment 10 includes a server 12 disposed in a cloud data center 14 and connected to an Internet or WAN 16 via a router or switch 17, as will be described in greater detail below. Although not shown in FIG. 3, it will be recognized that one or more cloud user devices on which are installed cloud clients may be connected to and access the cloud data center 14 via the Internet/WAN 16. A number of applications 19(1)-19(N) are executing on the server 12 and accessible via API calls from clients or from other applications. In some embodiments, one or more of the applications 19(1)-19(N) may be running as processes on a bare metal server, inside a guest virtual machine on a hypervisor, as a container on a bare metal server or hypervisor, or may be a uni-kernel.

In accordance with features of embodiments described herein, the server 12 includes an API rate limiter 20, which monitors resource usage of the server 12 (e.g., CPU, memory, disk consumption, etc.) and intercepts API calls received at the server and destined for one of the applications 19(1)-19(N), which API calls may originate from cloud clients via the Internet/WAN 16 or from other applications within the cloud data center 14. The API rate limiter 20 also has access to SLA guarantee information for each application 19(1)-19(N), as well as the current load on each application. The SLA guarantee information can be obtained by the rate limiter 20 querying the hosts to obtain the SLA profiles, as described in detail below. Alternatively, the rate limiter 20 may obtain the SLA profiles by querying the applications for their SLA profile or from the cloud orchestration system that provisions the applications and their SLAs. Similarly, the rate limiter 20 may query the server and the applications to obtain their current load information. Alternately, the rate limiter 20 may obtain this information from the cloud orchestration or cloud service assurance systems, which in turn obtains this information from/maintains this information for the applications and servers.

In operation, API traffic comes into the router/switch 17 and is routed toward the server 12. The rate limiter 20 checks host resource utilization against the SLA guarantees for the applications 19(1)-19(N) and the current load on the applications, and then drops/throttles or forwards API traffic to the various applications based on the comparison. In the scenario shown in FIG. 3, the API rate limiter 20 is checking usage against the incoming request and what the SLA guarantees made to the application owner by the cloud service provider. In particular, from a business standpoint, it is important to provide an SLA guarantee in accordance with what the application owner has paid and is specified in the application's settings. In addition, being aware of and making decisions based on the applicable SLA enables avoidance of rate limiting when it is unnecessary. For example, in a situation in which a Tier I application is not utilizing the 20% CPU that has been guaranteed to the application, a Tier III application may oversubscribe until the Tier I application needs the CPU.

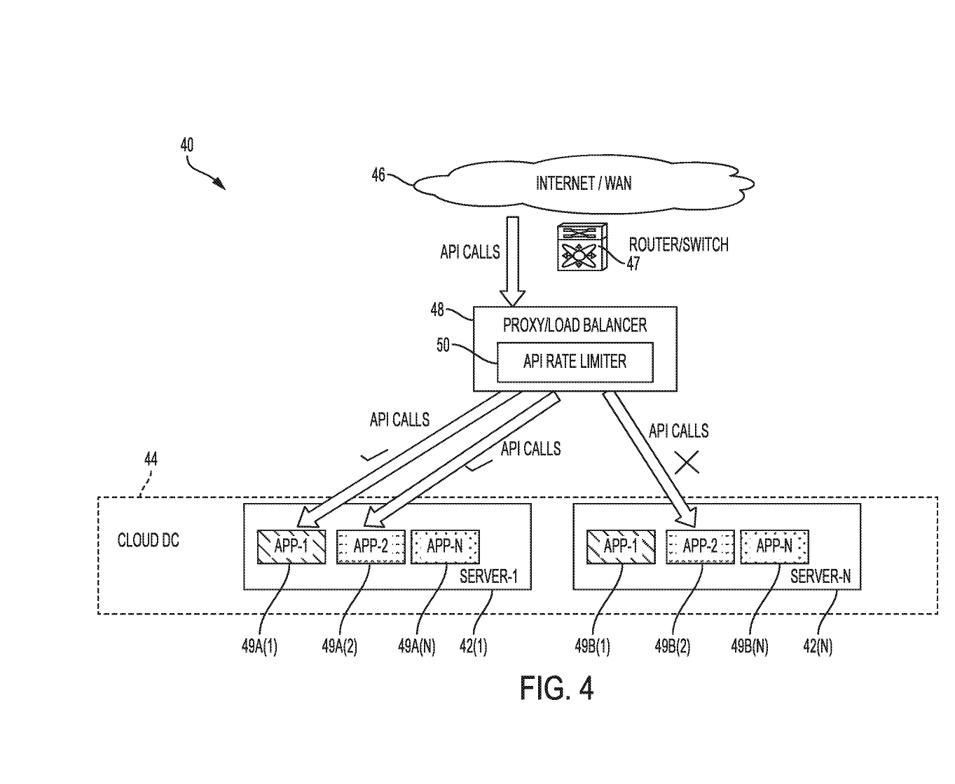

FIG. 4 is a simplified block diagram of cloud network 40 illustrating an alternative example scenario in which techniques for API rate limiting for cloud native applications based on host hardware regulations and application SLA guarantees may be implemented in accordance with embodiments described herein. As shown in FIG. 4, the network 40 includes a number of servers, represented in FIG. 4 by servers 42(1)-42(N), disposed in a cloud data center 44 and connected to an Internet or WAN 46 via a router or switch 47 and a proxy/load balancer 48, as will be described in greater detail below. Although not shown in FIG. 4, it will be recognized that one or more cloud user devices on which are installed cloud clients may be connected to and access the cloud data center 44 via the Internet/WAN 46. A number of applications 49A(1)-49A(N), 49B(1)-42B(N) are executing on the servers 42(1)-42(N) and accessible via API calls from clients or from other applications. In some embodiments, one or more of the applications 49A(1)-49A(N), 49B(1)-49B(N) may be running as processes on a bare metal server, inside a guest virtual machine on a hypervisor, as a container on a bare metal server or hypervisor, or may be a uni-kernel.

In accordance with features of embodiments described herein, an API rate limiter 50 is disposed in the proxy/load balancer 48, instead of in one of the servers, as with the embodiment illustrated in FIG. 3. The API rate limiter 50 monitors resource usage/load metrics on all of the servers 42(1)-42(N) (e.g., CPU, memory, disk consumption, etc.) and all of the applications 49A(1)-49B(N), 49B(1)-49B(N) and intercepts API calls received at the proxy/load balancer 48 and destined for one of the applications. The API calls intercepted by the rate limiter 50 may originate from cloud clients via the Internet/WAN 46 or from other applications within the cloud data center 44. The API rate limiter 50 also has access to SLA guarantee information for each application 49A(1)-49B(N), 49B(1)-49B(N), as well as the current load on each application, and the usage/load metrics on each server. As noted above, the SLA guarantee information can be obtained by the rate limiter 50 querying the hosts to obtain the SLA profiles, as described in detail below. Alternatively, the rate limiter 50 may obtain the SLA profiles by querying the applications for their SLA profile or from the cloud orchestration system that provisions the applications and their SLAs. Similarly, the rate limiter 50 may query the server and the applications to obtain their current load information. Alternately, the rate limiter 50 may obtain this information from the cloud orchestration or cloud service assurance system, which in turn obtains this information from/maintains this information for the applications and servers.

In operation, API traffic comes into the router/switch 47 and is routed toward the proxy/load balancer 48. The rate limiter 50 checks host resource utilization of all of the hosts in the cluster that the application is running on against the SLA guarantees for the applications on those hosts, as well as the current load on the applications, and then drops/throttles or forwards API traffic based to the various applications based on the comparison.

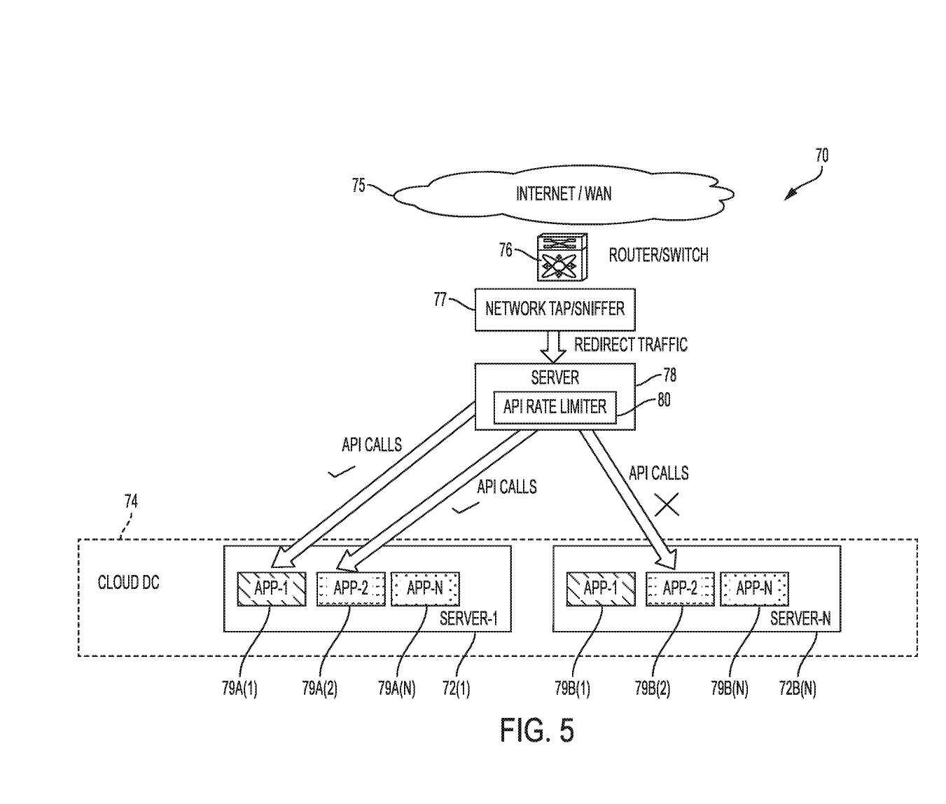

FIG. 5 is a simplified block diagram of cloud network 70 illustrating another alternative example scenario in which techniques for API rate limiting for cloud native applications based on host hardware regulations and application SLA guarantees may be implemented in accordance with embodiments described herein. As shown in FIG. 5, the network 70 includes a number of servers, represented in FIG. 5 by servers 72(1)-72(N), disposed in a cloud data center 74 and connected to an Internet or WAN 75 via a router or switch 76 and a network tap/sniffer 77 for redirecting traffic to a server 78, as will be described in greater detail below. Although not shown in FIG. 5, it will be recognized that one or more cloud user devices on which are installed cloud clients may be connected to and access the cloud data center 74 via the Internet/WAN 76. A number of applications 79A(1)-79A(N), 79B(1)-72B(N) are executing on the servers 72(1)-72(N) and accessible via API calls from clients or from other applications. In some embodiments, one or more of the applications 79A(1)-79A(N), 79B(1)-79B(N) may be running as processes on a bare metal server, inside a guest virtual machine on a hypervisor, as a container on a bare metal server or hypervisor, or may be a uni-kernel.

In accordance with features of embodiments described herein, an API rate limiter 80 is disposed in the server 78, instead of in one of the servers 72(1)-72(N), as with the embodiment illustrated in FIG. 3, or in a proxy/load balancer, as with the embodiment illustrated in FIG. 4. The API rate limiter 80 monitors resource usage/load metrics on all of the servers 72(1)-72(N) (e.g., CPU, memory, disk consumption, etc.) and all of the applications 79A(1)-79B(N), 79B(1)-79B(N) and receives API calls intercepted and sent to it by the network tap/sniffer 77, which are destined for one of the applications. The API calls intercepted by the rate limiter 80 may originate from cloud clients via the Internet/WAN 76 or from other applications within the cloud data center 74. The API rate limiter 80 also has access to SLA guarantee information for each application 79A(1)-79B(N), 79B(1)-79B(N), as well as the current load on each application and the usage/load metrics on each server. As noted above, the SLA guarantee information can be obtained by the rate limiter 80 querying the hosts to obtain the SLA profiles, as described in detail below. Alternatively, the rate limiter 80 may obtain the SLA profiles by querying the applications for their SLA profile or from the cloud orchestration system that provisions the applications and their SLAs. Similarly, the rate limiter 80 may query the server and the applications to obtain their current load information. Alternately, the rate limiter 80 may obtain this information from the cloud orchestration or cloud assurance system, which in turn obtains this information from/maintains this information for the applications and servers.

In operation, API traffic comes into the router/switch 76 and is intercepted by the network tap/sniffer 77, which redirects traffic to the server 78. At the server 78, the rate limiter 80 checks host resource utilization of all of the hosts in the cluster that the application is running on against the SLA guarantees for the applications on those hosts, as well as the current load on the applications, and then drops/throttles or forwards API traffic to the various applications based on the comparison.

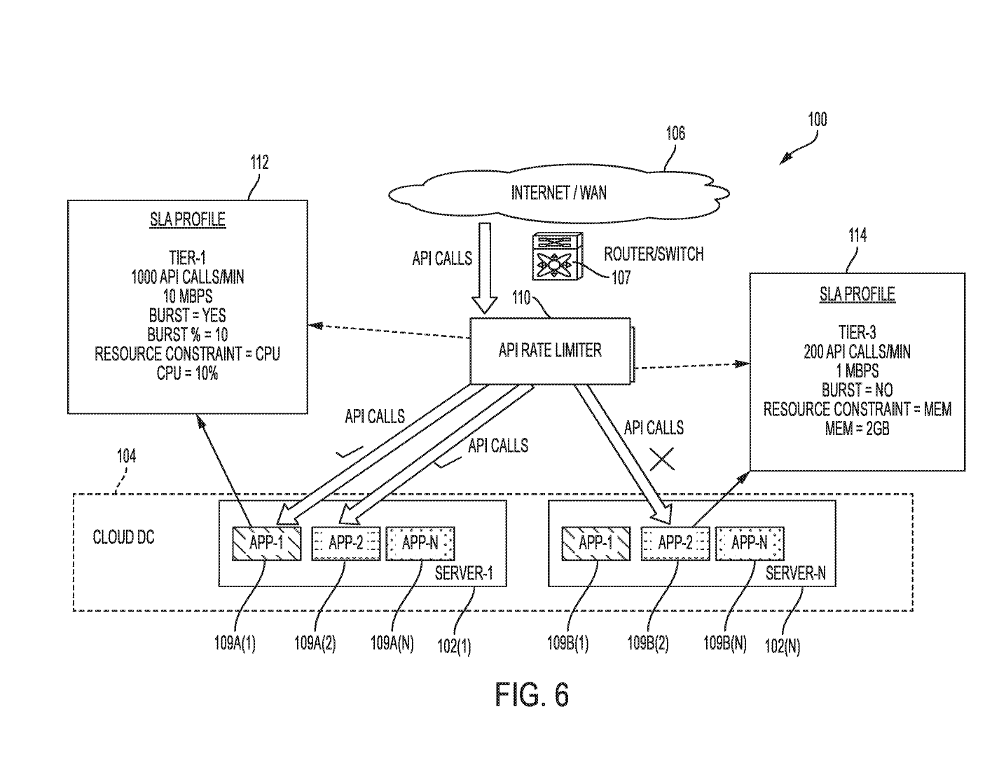

FIG. 6 is a simplified block diagram of cloud network 100 generally representative of the example scenarios illustrated in FIGS. 3-5 in which techniques for API rate limiting for cloud native applications based on host hardware regulations and application SLA guarantees may be implemented in accordance with embodiments described herein. As shown in FIG. 6, the network 100 includes a number of servers, represented in FIG. 100 by servers 102(1)-102(N), disposed in a cloud data center 104 and connected to an Internet or WAN 106 via a router or switch 107. Although not shown in FIG. 6, it will be recognized that one or more cloud user devices on which are installed cloud clients may be connected to and access the cloud data center 104 via the Internet/WAN 106. A number of applications 109A(1)-109A(N), 109B(1)-109B(N) are executing on the servers 102(1)-102(N) and accessible via API calls from clients or from other applications. In some embodiments, one or more of the applications 109A(1)-109A(N), 109B(1)-109B(N) may be running as processes on a bare metal server, inside a guest virtual machine on a hypervisor, as a container on a bare metal server or hypervisor, or may be a uni-kernel.

In accordance with features of embodiments described herein, an API rate limiter 110 is disposed between the router 107 and the applications 109. The rate-limiter could be disposed using one of the embodiments illustrated in and described with reference to in FIGS. 3-5. The API rate limiter 110 monitors resource usage/load metrics on all of the servers 102(1)-102(N) (e.g., CPU, memory, disk consumption, etc.) and all of the applications 109A(1)-109A(N), 109B(1)-109B(N) and intercepts API calls received at the router 107 and destined for one of the applications. The API calls intercepted by the rate limiter 110 may originate from cloud clients via the Internet/WAN 106 or from other applications within the cloud data center 104. The API rate limiter 110 also has access to SLA guarantee information for each application 109A(1)-109A(N), 109B(1)-109B(N), as well as the current load on each application and load/usage metrics on each server.

As noted above, the SLA guarantee information can be obtained by the rate limiter 110 querying the hosts to obtain the SLA profiles, as described in detail below. Alternatively, the rate limiter 110 may obtain the SLA profiles by querying the applications for their SLA profile or from the cloud orchestration system that provisions the applications and their SLAs. Similarly, the rate limiter 110 may query the server and the applications to obtain their current load information. Alternately, the rate limiter 110 may obtain this information from the cloud orchestration or cloud service assurance system, which in turn obtains this information from/maintains this information for the applications and servers.

In accordance with features of embodiments described herein, each bare-metal server, virtual machine, or container, has a profile/metadata associated therewith that specifies the SLA parameters guaranteed for it. Applications running on the server/VM/container can be mapped to this SLA Profile, and this profile/metadata can be used for rate-limiting purposes. In another embodiment, the SLA profiles can be associated directly with each Application, and there could be different SLA profiles for the Application depending on whether the application is running on a bare-metal server or on a virtual machine or in a container. As that application is orchestrated onto the cluster (bare-metal or virtual machine or container) and instantiated or moved between various hosts, those hosts would become aware of SLA to guarantee to the application. It also lets the hosts oversubscribe if a Tier I application isn't using the resources guaranteed to that application. A benefit of techniques described herein includes the fact that referring to SLA guarantees enables rate limiting to be avoided when it is not necessary. For example, if a Tier 1 application is not using the 20% CPU that it is guaranteed, embodiments herein enable a Tier II application to oversubscribe and use the free resources on the host until they are needed by an application to which they are guaranteed. Another example includes a case in which applications may be overprovisioned on a host and in the case of resource contention, the SLA parameters may be utilized to prioritize access to host resources for Tier 1 applications.

Referring to FIG. 6, a first SLA profile 112 is associated with the application 109A(1). The first SLA profile 112 specifies the SLA guarantees associated with the application 109A(1). In particular, the profile 112 indicates that the application 109A(1) is a Tier I application, is guaranteed 1000 API calls per minute, 10 Mbps of bandwidth, burst accommodation, and CPU resource constraint of 10%. A second SLA profile 114 is associated with the application 109B(2) and specifies SLA guarantees associated therewith. In particular, the profile 114 indicates that the application 109B(2) is a Tier III application, is guaranteed 200 API calls per minute, 1 Mbps of bandwidth, no burst accommodation, and memory resource constraint of 2 GB. As used herein, “burst accommodation” indicates a percentage up to which each parameter can burst. For example, if burst percentage is 10% and API rate is 1000 calls per minute, then the application can be bursted up to 1100 calls per minute if the server has the capacity to handle it. Similarly, 10 Mbps bandwidth can burst up to 11 Mbps. “X resource constraint,” where X identifies a resource, such as CPU or memory, indicates a parameter that can be a resource constraint. For example, CPU resource constraint of 10% means that the application is guaranteed 10% of the total CPU. By identifying CPU value as the resource constraint, the application is CPU intensive and this is the parameter that will likely be burst. Memory resource constraint is the memory consumed by the application out of the total memory available on the server. A memory resource constraint of 2 GB means that the application is guaranteed 2 GB out of the total RAM available on the server. Designating memory as the resource constraint identifies the application as memory intensive and memory is the parameter allowed to be bursted.

It should be noted that the parameters shown in and described with reference to FIG. 6 are for the sake of example only and that not all of the illustrated parameters will always be used and that other parameters may be included in alternative embodiments.

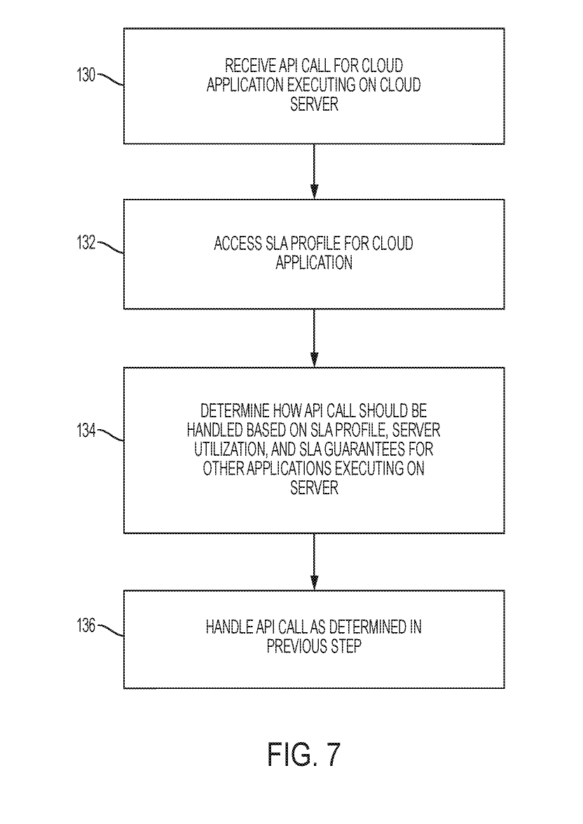

FIG. 7 is a flow diagram of steps that may be executed in connection with a technique for API rate limiting for cloud native applications based on host hardware regulations and application SLA guarantees in accordance with embodiments described herein. Referring to FIG. 7, in step 130, an API call for a particular cloud application executing on a server in a server cloud is received at the API rate limiting function. In step 132, an SLA profile for the application is accessed to determine SLA guarantees associated with the application. In step 134, current and historical resource utilization for the server, SLA guarantees for the remaining applications executing on the server, and the current load on each application are examined to determine how the API call should be handled. For example, in one embodiment, assuming a memory constraint of 2 GB, a determination is made as to how much memory on the server as a whole is being used, how much is being used by the present application, by other applications, and what is the SLA memory guarantee for the application. Assuming the application is consuming 1 GB, but is guaranteed 2 GB, and the server has 4 GB free out of total 64 GB RAM, and other applications on the server are Tier II, more API calls are allowed by the application because there is spare (unused) memory. In step 136, the API call is handled (e.g., forwarded, queued, or dropped) in accordance with the determination made in step 134.

In accordance with features of embodiments described herein, a mechanism is proposed for achieving intelligent, application and host resource usage aware rate limiting across a heterogeneous cloud infrastructure. In particular, host level utilization and utilization patterns taken into consideration when doing API rate-limiting and SLAs are configured on a per-application basis. The set SLAs are correlated against host and application usage, and incoming requests and API calls to a particular application are dropped, forwarded, or queued based on the SLA for the application and host resource utilization. Embodiments described herein may be applied for a single application running on a single host or to a distributed application running across multiple hosts in a cluster/cloud.

It will be recognized that the various network elements shown in the drawings may be implemented using one or more computer devices comprising software embodied in one or more tangible media for facilitating the activities described herein. The computer devices for implementing the elements may also include a memory device (or memory element) for storing information to be used in achieving the functions as outlined herein. Additionally, the computer devices may include one or more processors capable of executing software or an algorithm to perform the functions as discussed in this Specification. These devices may further keep information in any suitable memory element (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory element.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that in certain example implementations, various functions outlined herein may be implemented by logic encoded in one or more tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory element can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

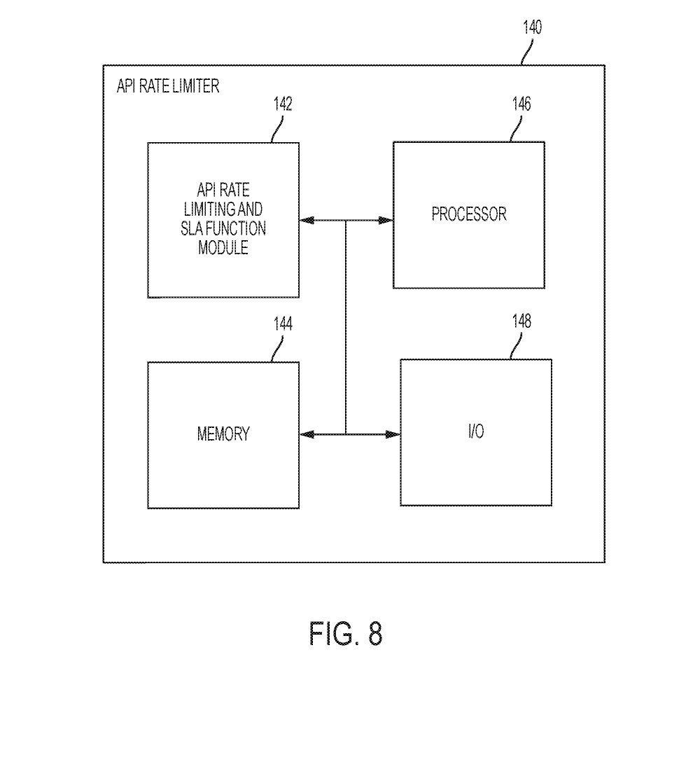

FIG. 8 illustrates a simplified block diagram of an API rate limiter 140 for implementing techniques for API rate limiting for cloud native applications based on host hardware regulations and application SLA guarantees in accordance with embodiments described herein. The API rate limiter 140 may be representative of any of the rate limiters shown and described herein, such as the rate limiter 20, 50, 80, 110. As shown in FIG. 8, the rate limiter 140 includes an API rate limiting and SLA function module 142 comprising software embodied in one or more tangible media for facilitating the activities described herein. In particular, the module 142 may include software for facilitating the processes illustrated in and described with reference to FIG. 7. The rate limiter 130 may also include a memory device 144 for storing information to be used in achieving the functions as outlined herein. Additionally, the rate limiter 130 may include a processor 146 that is capable of executing software or an algorithm (such as embodied in module 142) to perform the functions as discussed in this Specification. The node 140 may also include various I/O 148 necessary for performing functions described herein. As described with reference to FIGS. 3-6, the rate limiter 140 is functionally connected between an Internet/WAN and one or more applications executing on one or more cloud servers.

It will be recognized that the rate limiter 140 shown in FIG. 8 may be implemented using one or more computer devices comprising software embodied in one or more tangible media for facilitating the activities described herein. The computer device for implementing the transmitter and receiver elements may also include a memory device (or memory element) for storing information to be used in achieving the functions as outlined herein. Additionally, the computer device for implementing the transmitter and receiver elements may include a processor that is capable of executing software or an algorithm to perform the functions as discussed in this Specification, including but not limited to the functions illustrated in and described with reference to FIG. 7. These devices may further keep information in any suitable memory element (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory element.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that in certain example implementations, the functions outlined herein and specifically illustrated in FIG. 7 may be implemented by logic encoded in one or more tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory element can store data used for the operations described herein. This includes the memory element being able to store software, logic, code, or processor instructions that are executed to carry out the activities described in this Specification, including but not limited to the functions illustrated in and described with reference to FIG. 7. A processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

It should be noted that much of the infrastructure discussed herein can be provisioned as part of any type of network element. As used herein, the term “network element” or “network device” can encompass computers, servers, network appliances, hosts, routers, switches, gateways, bridges, virtual equipment, load-balancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

In one implementation, network elements/devices can include software to achieve (or to foster) the management activities discussed herein. This could include the implementation of instances of any of the components, engines, logic, etc. shown in the FIGURES. Additionally, each of these devices can have an internal structure (e.g., a processor, a memory element, etc.) to facilitate some of the operations described herein. In other embodiments, these management activities may be executed externally to these devices, or included in some other network element to achieve the intended functionality. Alternatively, these network devices may include software (or reciprocating software) that can coordinate with other network elements in order to achieve the management activities described herein. In still other embodiments, one or several devices may include any suitable algorithms, hardware, software, components, modules, interfaces, or objects that facilitate the operations thereof.

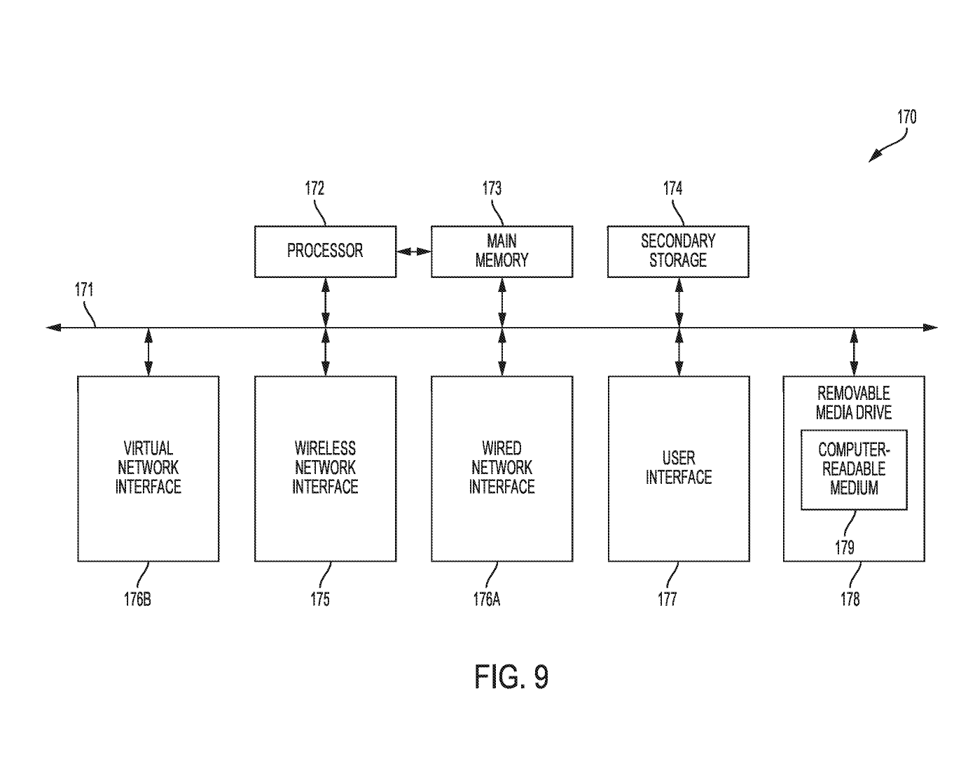

Turning to FIG. 9, illustrated therein is a simplified block diagram of an example machine (or apparatus) 170, which in certain embodiments may comprise the API rate limiter, that may be implemented in embodiments illustrated in and described with reference to the FIGURES provided herein. The example machine 170 corresponds to network elements and computing devices that may be deployed in environments illustrated in described herein. In particular, FIG. 9 illustrates a block diagram representation of an example form of a machine within which software and hardware cause machine 170 to perform any one or more of the activities or operations discussed herein. As shown in FIG. 9, machine 170 may include a processor 172, a main memory 173, secondary storage 174, a wireless network interface 175, a wired network interface 176A, a virtual network interface 176B, a user interface 177, and a removable media drive 178 including a computer-readable medium 179. A bus 171, such as a system bus and a memory bus, may provide electronic communication between processor 172 and the memory, drives, interfaces, and other components of machine 170. Machine 170 may be a physical or a virtual appliance, for example a virtual router running on a hypervisor or running within a container.

Processor 172, which may also be referred to as a central processing unit (“CPU”), can include any general or special-purpose processor capable of executing machine readable instructions and performing operations on data as instructed by the machine readable instructions. Main memory 173 may be directly accessible to processor 172 for accessing machine instructions and may be in the form of random access memory (“RAM”) or any type of dynamic storage (e.g., dynamic random access memory (“DRAM”)). Secondary storage 174 can be any non-volatile memory such as a hard disk, which is capable of storing electronic data including executable software files. Externally stored electronic data may be provided to computer 170 through one or more removable media drives 178, which may be configured to receive any type of external media such as compact discs (“CDs”), digital video discs (“DVDs”), flash drives, external hard drives, etc.

Wireless, wired, and virtual network interfaces 175, 176A and 176B can be provided to enable electronic communication between machine 170 and other machines or nodes via networks. In one example, wireless network interface 175 could include a wireless network controller (“WNIC”) with suitable transmitting and receiving components, such as transceivers, for wirelessly communicating within a network. Wired network interface 176A can enable machine 170 to physically connect to a network by a wire line such as an Ethernet cable. Both wireless and wired network interfaces 175 and 176A may be configured to facilitate communications using suitable communication protocols such as, for example, Internet Protocol Suite (“TCP/IP”). Machine 170 is shown with both wireless and wired network interfaces 175 and 176A for illustrative purposes only. While one or more wireless and hardwire interfaces may be provided in machine 170, or externally connected to machine 170, only one connection option is needed to enable connection of machine 170 to a network.

A user interface 177 may be provided in some machines to allow a user to interact with the machine 170. User interface 177 could include a display device such as a graphical display device (e.g., plasma display panel (“PDP”), a liquid crystal display (“LCD”), a cathode ray tube (“CRT”), etc.). In addition, any appropriate input mechanism may also be included such as a keyboard, a touch screen, a mouse, a trackball, voice recognition, touch pad, and an application programming interface (API), etc.

Removable media drive 178 represents a drive configured to receive any type of external computer-readable media (e.g., computer-readable medium 179). Instructions embodying the activities or functions described herein may be stored on one or more external computer-readable media. Additionally, such instructions may also, or alternatively, reside at least partially within a memory element (e.g., in main memory 173 or cache memory of processor 172) of machine 170 during execution, or within a non-volatile memory element (e.g., secondary storage 174) of machine 170. Accordingly, other memory elements of machine 170 also constitute computer-readable media. Thus, “computer-readable medium” is meant to include any medium that is capable of storing instructions for execution by machine 170 that cause the machine to perform any one or more of the activities disclosed herein.

Not shown in FIG. 9 is additional hardware that may be suitably coupled to processor 172 and other components in the form of memory management units (“MMU”), additional symmetric multiprocessing elements, physical memory, peripheral component interconnect (“PCI”) bus and corresponding bridges, small computer system interface (“SCSI”)/integrated drive electronics (“IDE”) elements, etc. Machine 170 may include any additional suitable hardware, software, components, modules, interfaces, or objects that facilitate the operations thereof. This may be inclusive of appropriate algorithms and communication protocols that allow for the effective protection and communication of data. Furthermore, any suitable operating system may also be configured in machine 170 to appropriately manage the operation of the hardware components therein.

The elements, shown and/or described with reference to machine 170, are intended for illustrative purposes and are not meant to imply architectural limitations of machines such as those utilized in accordance with the present disclosure. In addition, each machine may include more or fewer components where appropriate and based on particular needs and may run as virtual machines or virtual appliances. As used herein in this Specification, the term “machine” is meant to encompass any computing device or network element such as servers, virtual servers, logical containers, routers, personal computers, client computers, network appliances, switches, bridges, gateways, processors, load balancers, wireless LAN controllers, firewalls, or any other suitable device, component, element, or object operable to affect or process electronic information in a network environment.

In one example implementation, certain network elements or computing devices may be implemented as physical and/or virtual devices and may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

Furthermore, in the embodiments described and shown herein, some of the processors and memory elements associated with the various network elements may be removed, or otherwise consolidated such that a single processor and a single memory location are responsible for certain activities. Alternatively, certain processing functions could be separated and separate processors and/or physical machines could implement various functionalities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of the example embodiments, one or more memory can store data used for the various operations described herein. This includes at least some of the memory elements being able to store instructions (e.g., software, logic, code, etc.) that are executed to carry out the activities described in this Specification. A processor can execute any type of instructions associated with the data to achieve the operations detailed herein in this Specification. In one example, one or more processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable read only memory (“EEPROM”)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

Components of environments illustrated herein may keep information in any suitable type of memory (e.g., random access memory (“RAM”), read-only memory (“ROM”), erasable programmable ROM (“EPROM”), electrically erasable programmable ROM (“EEPROM”), etc.), software, hardware, or in any other suitable component, device, element, or object where appropriate and based on particular needs. Any of the memory items discussed herein should be construed as being encompassed within the broad term “memory element.” The information being read, used, tracked, sent, transmitted, communicated, or received by network environments described herein could be provided in any database, register, queue, table, cache, control list, or other storage structure, all of which can be referenced at any suitable timeframe. Any such storage options may be included within the broad term “memory element” as used herein. Similarly, any of the potential processing elements and modules described in this Specification should be construed as being encompassed within the broad term “processor.”

Note that with the numerous examples provided herein, interaction may be described in terms of two, three, four, or more network elements. However, this has been done for purposes of clarity and example only. It should be appreciated that the system can be consolidated in any suitable manner. Along similar design alternatives, any of the illustrated computers, modules, components, and elements of the FIGURES may be combined in various possible configurations, all of which are clearly within the broad scope of this Specification. In certain cases, it may be easier to describe one or more of the functionalities of a given set of flows by only referencing a limited number of network elements. It should be appreciated that embodiments described herein, as shown in the FIGURES, and teachings thereof are readily scalable and can accommodate a large number of components, as well as more complicated/sophisticated arrangements and configurations. Accordingly, the examples provided should not limit the scope or inhibit the broad teachings of the system as potentially applied to a myriad of other architectures.

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

In the foregoing description, for purposes of explanation, numerous specific details are set forth in order to provide a thorough understanding of the disclosed embodiments. It will be apparent to one skilled in the art, however, that the disclosed embodiments may be practiced without these specific details. In other instances, structure and devices are shown in block diagram form in order to avoid obscuring the disclosed embodiments. In addition, references in the Specification to “one embodiment”, “example embodiment”, “an embodiment”, “another embodiment”, “some embodiments”, “various embodiments”, “other embodiments”, “alternative embodiment”, etc. are intended to mean that any features (e.g., elements, structures, modules, components, steps, operations, characteristics, etc.) associated with such embodiments are included in one or more embodiments of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
intercepting an API call destined for a first application executing on a host server;
accessing a Service Level Agreement (“SLA”) profile for the first application, wherein the SLA profile includes SLA values indicating performance guarantees for the first application;
determining resource utilization for the host server and the first application;
comparing the performance guarantees with the determined resource utilization to determine whether performance guarantees can be met if the API call is forwarded to the first application based on the determined resource utilization;
if it determined that the performance guarantees cannot be met if the API call is forwarded to the first application, refraining from forwarding the API call to the first application; and
if it is determined that the performance guarantees can be met if the API call is forwarded to the first application, forwarding the API call to the first application.

2. The method of claim 1, wherein the refraining from forwarding the API call comprises at least one of dropping the API call and queuing the API call.

3. The method of claim 1 further comprising:
accessing an SLA profile for a second application executing on the host server, wherein the SLA profile for the second application indicates performance guarantees for the second application;
wherein the determining resource utilization comprises determining resource utilization for the host server and the first and second applications; and
wherein the comparing further comprises comparing the performance guarantees for the first application with the performance guarantees for the second application and the determined resource utilization to determine whether the performance guarantees for the first application and the performance guarantees for the second application can be met if the API call is forwarded to the first application based on the determined resource utilization.

4. The method of claim 1 wherein the first application comprises a plurality of instances of the first application, the host server comprises a plurality of host servers, and each of the instances of the first application is executing on one of the host servers, and wherein the comparing further comprises:
comparing the performance guarantees for the first application against a resource utilization of all of the instances of the first application and a resource utilization of all of the host servers to determine whether the performance guarantees can be met if the API call is forwarded to the first application and if so, to which of the instances the API call should be forwarded.

5. The method of claim 4, wherein the intercepting is performed by at least one of one of the host servers and a network element connected to at least one of the host servers.

6. The method of claim 3 wherein the first application comprises a plurality of instances of the first application, the second application comprises a plurality of instances of the second application, and the host server comprises a plurality of host servers and each of the instances of the first and second applications is executing on one of the host servers, and wherein the comparing further comprises:
comparing the performance guarantees for the first application against a resource utilization of all instances of the first and second applications and a resource utilization of all of the host servers to determine whether the performance guarantees can be met if the API call is forwarded to the first application and if so, to which of the instances the API call should be forwarded.

7. The method of claim 1, wherein the values included in the SLA profile comprise meta-data specifying at least one of guarantees and constraints for at least one of resource types and application tiers.

8. The method of claim 1, wherein the SLA profile is associated with the host server and the first application inherits SLA values defined in the SLA profile.

9. The method of claim 8, wherein the SLA profile is selected from a plurality of different SLA profiles having different performance guarantees for the first application, wherein the selected SLA profile is selected based on whether the first application is instantiated on a bare-metal server, on a virtual machine, as a container, or as an uni-kernel.

10. One or more non-transitory tangible media that includes code for execution and when executed by a processor is operable to perform operations comprising:
intercepting an API call destined for a first application executing on a host server;
accessing a Service Level Agreement (“SLA”) profile for the first application, wherein the SLA profile includes SLA values indicating performance guarantees for the first application;
determining resource utilization for the host server and the first application;
comparing the performance guarantees with the determined resource utilization to determine whether performance guarantees can be met if the API call is forwarded to the first application based on the determined resource utilization;
if it determined that the performance guarantees cannot be met if the API call is forwarded to the first application, refraining from forwarding the API call to the first application; and
if it is determined that the performance guarantees can be met if the API call is forwarded to the first application, forwarding the API call to the first application.

11. The media of claim 10, wherein the refraining from forwarding the API call comprises at least one of dropping the API call and queuing the API call.

12. The media of claim 10, wherein the operations further comprise:
accessing an SLA profile for a second application executing on the host server, wherein the SLA profile for the second application indicates performance guarantees for the second application;
wherein the determining resource utilization comprises determining resource utilization for the host server and the first and second applications; and
wherein the comparing further comprises comparing the performance guarantees for the first application with the performance guarantees for the second application and the determined resource utilization to determine whether the performance guarantees for the first application and the performance guarantees for the second application can be met if the API call is forwarded to the first application based on the determined resource utilization.

13. The media of claim 10, wherein the first application comprises a plurality of instances of the first application, the host server comprises a plurality of host servers, and each of the instances of the first application is executing on one of the host servers, and wherein the comparing further comprises:
comparing the performance guarantees for the first application against a resource utilization of all of the instances of the first application and a resource utilization of all of the host servers to determine whether the performance guarantees can be met if the API call is forwarded to the first application and if so, to which of the instances the API call should be forwarded.

14. The media of claim 12, wherein the first application comprises a plurality of instances of the first application, the second application comprises a plurality of instances of the second application, and the host server comprises a plurality of host servers and each of the instances of the first and second applications is executing on one of the host servers, and wherein the comparing further comprises:
comparing the performance guarantees for the first application against a resource utilization of all instances of the first and second applications and a resource utilization of all of the host servers to determine whether the performance guarantees can be met if the API call is forwarded to the first application and if so, to which of the instances the API call should be forwarded.

15. The method of claim 10, wherein the SLA profile is selected from a plurality of different SLA profiles having different performance guarantees for the first application, wherein the selected SLA profile is selected based on whether the first application is instantiated on a bare-metal server, on a virtual machine, as a container, or as an uni-kernel.

16. An apparatus comprising:
a memory element configured to store data;
a processor operable to execute instructions associated with the data; and
an API rate limiter module configured to:
intercept an API call destined for a first application executing on a host server;
access a Service Level Agreement (“SLA”) profile for the first application, wherein the SLA profile includes SLA values indicating performance guarantees for the first application;
determine resource utilization for the host server and the first application;
compare the performance guarantees with the determined resource utilization to determine whether performance guarantees can be met if the API call is forwarded to the first application based on the determined resource utilization;
if it determined that the performance guarantees cannot be met if the API call is forwarded to the first application, refrain from forwarding the API call to the first application; and
if it is determined that the performance guarantees can be met if the API call is forwarded to the first application, forward the API call to the first application.

17. The apparatus of claim 16, wherein the refraining from forwarding the API call comprises at least one of dropping the API call and queuing the API call.

18. The apparatus of claim 16, wherein the API rate limiter module is further configured to:
access an SLA profile for a second application executing on the host server, wherein the SLA profile for the second application indicates performance guarantees for the second application;
wherein the determining resource utilization comprises determining resource utilization for the host server and the first and second applications; and
wherein the comparing further comprises comparing the performance guarantees for the first application with the performance guarantees for the second application and the determined resource utilization to determine whether the performance guarantees for the first application and the performance guarantees for the second application can be met if the API call is forwarded to the first application based on the determined resource utilization.

19. The apparatus of claim 16, wherein the first application comprises a plurality of instances of the first application, the host server comprises a plurality of host servers, and each of the instances of the first application is executing on one of the host servers, and wherein the comparing further comprises:
comparing the performance guarantees for the first application against a resource utilization of all of the instances of the first application and a resource utilization of all of the host servers to determine whether the performance guarantees can be met if the API call is forwarded to the first application and if so, to which of the instances the API call should be forwarded.

20. The apparatus of claim 18, wherein the first application comprises a plurality of instances of the first application, the second application comprises a plurality of instances of the second application, and the host server comprises a plurality of host servers and each of the instances of the first and second applications is executing on one of the host servers, and wherein the comparing further comprises:
comparing the performance guarantees for the first application against a resource utilization of all instances of the first and second applications and a resource utilization of all of the host servers to determine whether the performance guarantees can be met if the API call is forwarded to the first application and if so, to which of the instances the API call should be forwarded.
